(19) United States
(12) Patent Application Publication
(10) Pub. No.: US 2018/0276573 A1
(43) Pub. Date: Sep. 27, 2018

(54) PROVIDING TRAVEL RELATED CONTENT CUSTOMIZED FOR USERS

(71) Applicant: Facebook, Inc., Menlo Park, CA (US)

(72) Inventors: Robert P. Otillar, Mountain View, CA (US); Ido Wakrat, London (GB)

(21) Appl. No.: 15/466,786

(22) Filed: Mar. 22, 2017

(51) Int. Cl. G06Q 10/02; G06N 99/00; G06Q 30/02

(52) U.S. Cl. CPC G06Q 10/02; G06Q 30/0226; G06N 99/005

(57) ABSTRACT

An online system uses rules and/or machine learning models to provide travel related content items to users. The online system may determine when a user is likely to travel and provide the content items in advance of a trip. The online system may also provide content items during a trip that indicate modifications to the user's itinerary, for example, adding a rental car, upgrading a flight ticket, or upgrading a hotel room. Further, the online system may provide a content item after a user has checked out of a hotel that describes a loyalty program of the hotel. In one example, the online system trains machine learning models using feature vectors derived based on trips taken by a population of users of the online system and itinerary information from third parties. The content items may be generated based on information provided from the third parties.

### BACKGROUND

### 1. Field of Art

This disclosure generally relates to provide travel related content and to predict the actions of users of online systems who are traveling, such as by using machine learning to make the predictions.

### 2. Description of the Related Art

An online system typically has access to large amounts of information describing actions performed by users that may be of interest to other users of the online system. The online system allows its users to connect to and to communicate with other users. Users may create user profiles on the online system that are tied to their identities and include information about the users, such as interests and demographic information. Because of the increasing popularity of these types of online systems and the increasing amount of user-specific information maintained by such online systems, an online system provides an ideal forum to increase awareness about items to online system users. The online system further sends content items to users such as news feed stories including photos, videos, and the like.

Online systems prefer to deliver content items to users that are likely to be of interest to the users. By sending content items that are unlikely to be of interest to users, an online system wastes resources (e.g., computing resources and networking resources) and provides a poor user experience. When users are traveling or planning a trip, it is challenging to determine which particular types of content items a user will likely want to interact with. For example, if a user has already booked flights to, and a hotel in, Hawaii, the user will likely not be interested in content items describing other flights to and hotels at Hawaii during the same time frame.

### SUMMARY

An online system provides travel-related content items to users, such as by using machine learning models and/or rules to define the appropriate users for the content. The online system may determine when a user is likely to travel and provide the content items in advance of a trip. The online system may also provide content items during a trip that indicate modifications to the user's itinerary, such as adding a rental car, upgrading a flight ticket, or upgrading a hotel room. Further, the online system may provide a content item after a user has checked out of a hotel that describes a loyalty program of the hotel. In one example, the online system uses rules to define the users meeting the travel-requirements for the content or trains machine learning models using feature vectors derived based on trips taken by a population of users of the online system and itinerary information from third parties. The content items may be provided by third parties and/or generated based on information provided from the third parties.

In one embodiment, the online system processes information indicating that users of a population frequently joined a loyalty program of a third party associated with a hotel that the users stayed at for their trips, e.g., using rules and/or a machine learning model. The users of the population may have characteristics in common to a target user, for instance, based on demographics or affinities indicated by information on the online system. The online system selects a content item describing an incentive that the target user may acquire if the target user joins the loyalty program. The online system provides the content item to the target user's client device shortly after the target user checks out of the hotel.

### BRIEF DESCRIPTION OF DRAWINGS

FIG. 1 is a diagram of a system environment for providing travel related content items according to one embodiment.

FIG. 2 is a block diagram illustrating the architecture of an online system for providing travel related content items according to one embodiment.

FIG. 3A is a diagram of a calendar of a user's actions according to one embodiment.

FIG. 3B is a data flow diagram of filtering a user's actions according to one embodiment.

FIG. 3C shows example travel related content items provided before a user's trip according to one embodiment.

FIG. 4A shows example travel related content items provided during a user's trip according to one embodiment.

FIG. 4B shows example travel related content items provided during a user's trip to modify the user's trip according to one embodiment.

FIG. 5 shows example travel related content items associated with a loyalty program according to one embodiment.

FIG. 6A is a flowchart illustrating a process for providing a travel related content item before a user's trip according to one embodiment.

FIG. 6B is a flowchart illustrating another process for providing a travel related content item before a user's trip according to one embodiment.

FIG. 7A is a flowchart illustrating a process for providing a travel related content item during a user's trip according to one embodiment.

FIG. 7B is a flowchart illustrating another process for providing a travel related content item during a user's trip according to one embodiment.

FIG. 8A is a flowchart illustrating a process for providing a travel related content item during a user's trip according to one embodiment.

FIG. 8B is a flowchart illustrating another process for providing a travel related content item during a user's trip according to one embodiment.

FIG. 9A is a flowchart illustrating a process for providing a travel related content item associated with a loyalty program according to one embodiment.

FIG. 9B is a flowchart illustrating another process for providing a travel related content item associated with a loyalty program according to one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. System Overview

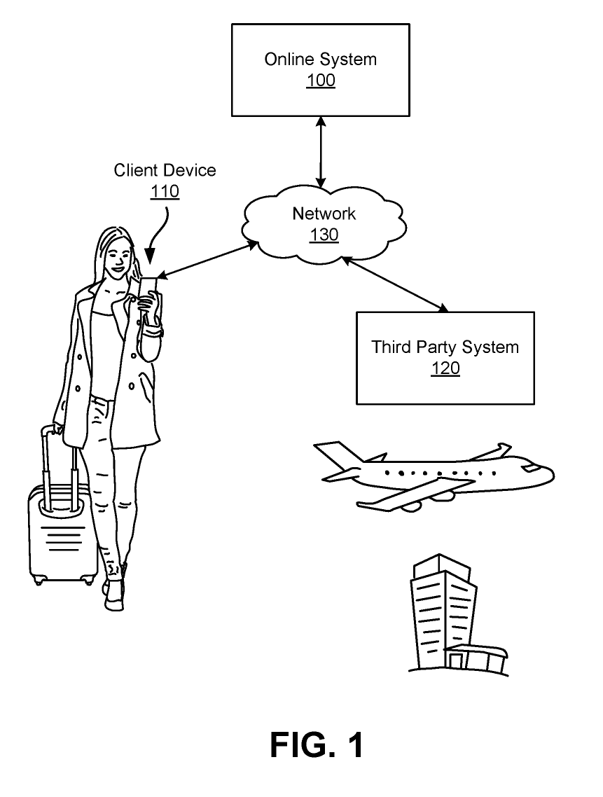

FIG. 1 is a diagram of a system environment for providing travel related content items according to one embodiment. The system architecture includes an online system 100, a client device 110 of a user of the online system 100, and one or more third party systems 120. The various systems shown in FIG. 1 are connected to each other via a network 130. In other embodiments, different and/or additional entities can be included in the system architecture.

The online system 100 includes a computing environment that allows users of the online system 100 to communicate or otherwise interact with each other and access content. The online system 100 receives information about the users, such as user profile information and information about actions performed by users on the online system 100 or a third party system 120. The online system 100 also receives information (e.g., describing flight or hotel reservations that a user made to plan for a trip or user searches for flights or hotels) from third party systems 120. Based on the received information, the online system 100 can use one or more machine learning models to predict a user's intention to take a trip and to predict other actions associated with the trip that may be performed by the user. The online system 100 may use the machine learning models to select travel-related content items and provide the content items for display on the client device 110 of a user before, during, or after the trip.

The client device 110 is a computing device capable of receiving user input as well as transmitting and/or receiving data via the network 130. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 130. In one embodiment, a client device 110 executes an application allowing a user of the client device 110 to interact with the online system 100 or a third party system 120. For example, a client device 110 executes a browser application to enable interaction between the client device 110 and the online system 100 via the network 130. In another embodiment, a client device 110 interacts with the online system 100 through an application programming interface (API) running on a native operating system of the client device 110, such as IOS® or ANDROID™.

The third party system 120 includes a computer server outside of the domain of the online system 100. The third party system 120 may be an application provider communicating information describing applications for execution by a client device 110 or communicating data to client devices 110 for use by an application executing on the client device 110. In other embodiments, a third party system 120 provides content or other information for presentation via a client device 110. In one embodiment, the third party system 120 communicates content (e.g., a website or HTML code) from a computer server of the third party system 120 to a computer server of the online system 100. The content may be created by a third party entity that owns or is associated with the third party system 120. The third party may be a company or other type of organization offering a product (e.g., a tangible object or an intangible service), or message that the company wishes to promote. For example, the third party may provide travel related services such as air, ground, or sea transportation, or hospitality services such as lodging and entertainment.

The network 130 includes any combination of local area and/or wide area networks, using both wired and/or wireless communication systems. In one embodiment, the network 130 uses standard communications technologies and/or protocols. For example, the network 130 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 130 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130 may be represented using any suitable format, such as hypertext markup language (HTML) or extensible markup language (XML). In some embodiments, all or some of the communication links of the network 130 may be encrypted using any suitable technique or techniques.

For sake of example, the description throughout will refer to an example user of the online system 100 named Sheryl. Sheryl interacts with the online system 100 using the client device 110, for example, a mobile smartphone. Sheryl is a 25 year old female professional living in Los Angeles, Calif., who travels for her job. For an upcoming trip to San Francisco, Sheryl may book a flight through a third party system 120 associated with an airline called “Earhart Flights.” Further, Sheryl may book a hotel room through another third party system 120 associated with a hotel called “SF Hotels.” The features described herein with reference to examples with Sheryl may also be included in other embodiments of the invention, not necessarily including Sheryl, Earhart Flights, SF Hotels, etc.

### II. Example System Architecture of Online System

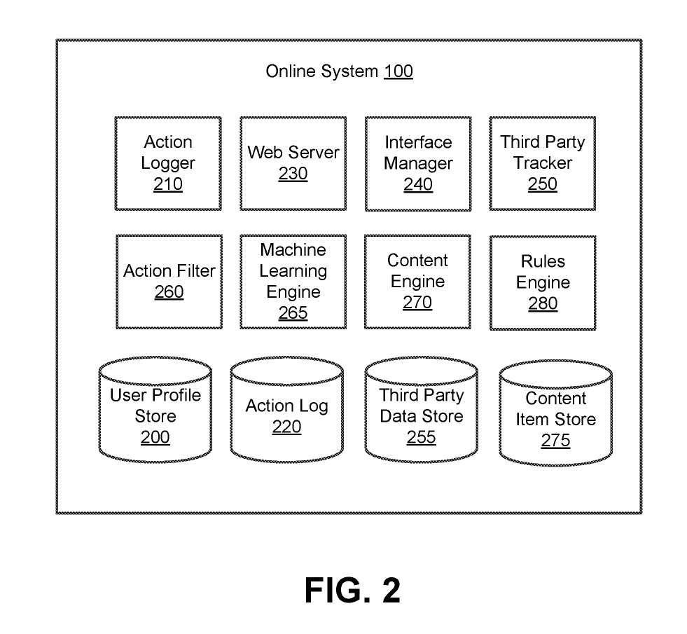

FIG. 2 is a block diagram illustrating the architecture of an online system 100 for providing travel related content items according to one embodiment. The online system 100 includes a user profile store 200, action logger 210, action log 220, web server 230, interface manager 240, third party tracker 250, third party data store 255, action filter 260, machine learning engine 265, content engine 270, content item store 275, and rules engine 280. In other embodiments, the online system 100 may include additional, fewer, or different components for various applications. Conventional components such as network interfaces, security functions, load balancers, failover servers, management and network operations consoles, and the like are not shown so as to not obscure the details of the system architecture.

The user profile store 200 stores user profiles associated with each user of the online system 100. A user profile includes declarative information about the user that was explicitly shared by the user and may also include profile information inferred by the online system 100. In one embodiment, a user profile includes multiple data fields, each describing one or more attributes of the corresponding user of the online system 100. Examples of information stored in a user profile include biographic, demographic, and other types of descriptive information, such as work experience, educational history, gender, hobbies or preferences, location, itinerary information of past trips, and the like.

A user profile may also store other information provided by the user, for example, images or videos. In certain embodiments, images of users may be tagged with identification information of users of the online system 100 displayed in an image. A user profile in the user profile store 200 may also maintain references to actions by the corresponding user performed on the online system 100, e.g., related to trips taken by the user or actions performed while the user planned a trip. The user profile store 200 further stores data describing one or more relationships between different users and allows users to specify their relationships with other users. For example, these user-defined relationships allow users to generate relationships with other users that parallel the user's real-life relationships, such as friends, co-workers, partners, and the like.

The user profile store 200 can store user profiles associated with individuals, as well as user profiles associated with entities such as businesses or organizations, e.g., that own a third party system 120. This allows an entity to establish a presence on the online system 100 for connecting and exchanging content with other users of the online system 100. The entity may post information about itself, about items associated with the entity, for example, travel related services (e.g., transportation or lodging) offered by the entity, or provide other information to users of the online system 100 using a brand page associated with the entity's user profile. Users of the online system 100 may connect to the brand page to receive information posted to the brand page or to receive information from the brand page. A user profile associated with the brand page may include information about the entity itself, providing users with background or informational data about the entity.

The action logger 210 receives communications about user actions internal to and/or external to the online system 100, populating the action log 220 with information about user actions. Examples of actions include adding a connection to another user, sending a message to another user, uploading an image, reading a message from another user, viewing content associated with another user, attending an event posted by another user, viewing a website of the online system 100 or third party system 120, performing on online search using certain keywords (e.g., related to hotels in San Francisco, flights from LAX to SFO, or rental cars at SFO), among others. In addition, a number of actions may involve an object and one or more particular users, so these actions are associated with those users as well and stored in the action log 220.

The action log 220 may be used by the online system 100 to track user actions on the online system 100, as well as actions on third party systems 120 that communicate information to the online system 100. Users may interact with various objects on the online system 100, and the action logger 210 stores information describing these interactions in the action log 220. Examples of interactions with objects include: viewing products on a brand page, commenting on posts, sharing links, and checking-in to physical locations via a mobile device, accessing content items, checking out of a hotel, performing at least a portion of a process to acquire a product, service, or other type of item available from a third party system 120, and any other interactions. Additional examples of interactions with objects on the online system 100 that are included in the action log 220 include: acquiring a product from a third party system 120, commenting on a photo album, communicating with a user, establishing a connection with an object, joining an event to a calendar, joining a group, creating an event, authorizing an application, using an application, and expressing a preference for an object (“liking” the object).

Additionally, the action log 220 may record a user's interactions with content (e.g., sponsored or non-sponsored content) on the online system 100 as well as with other applications operating on the online system 100. In some embodiments, data from the action log 220 is used to infer interests or preferences of a user, augmenting the interests included in the user's user profile and allowing a more complete understanding of user preferences. The action log 220 can record information about client devices 110 that a user uses to interact with the online system 100. For example, the action log 220 records whether the user used a laptop computer or smartphone client device to interact with the online system 100. Further, the action log 220 may include information about the types of client devices 110, e.g., smartphone running an IOS® or ANDROID™ operating system.

The action log 220 may also store user actions performed on a third party system 120, such as an external website, and communicated to the online system 100. For example, the external website may recognize a user of an online system 100 through a social plug-in enabling the external website to identify the user of the online system 100. Since users of the online system 100 are uniquely identifiable, external websites may communicate information about a user's actions outside of the online system 100 to the online system 100 for association with the user. Hence, the action log 220 can record information about actions that users perform on a third party system 120 including webpage viewing histories, content that were engaged, acquisitions made, and other patterns from past actions. The action log 220 can also store information about user actions performed on a third party system 120 received from the third party tracker 250, which is further described below.

The web server 230 links the online system 100 via the network 130 to the client devices 110. The web server 230 serves web pages, as well as other web-related content, such as JAVA®, FLASH®, XML and so forth. The web server 230 may receive and route messages between the online system 100 and the client device 110, for example, instant messages, queued messages (e.g., email), text messages, short message service (SMS) messages, or messages sent using any other suitable messaging technique. A user may send a request to the web server 230 to upload information (e.g., images or videos) that are stored in the user profile store 200. Additionally, the web server 230 may provide application programming interface (API) functionality to send data directly to native client device operating systems, such as IOS®, ANDROID™, WEBOS® or RIM®.

The interface manager 240 generates graphical user interfaces presenting information from the online system 100. For example, the graphical user interfaces display content items, e.g., travel related information, products, and services, notifications, news feed stories, brand pages, etc., on client devices 110 of users of the online system 100. The content items may be based on information from the user profile store 200 or the action log 220, or based on a user's predicted actions. The user may provide information to the online system 100 via the user interface manager 240, e.g., interactions performed by users with content items on the online system 100. Similarly, the third party system 120 may provide information to the online system 100 via the user interface manager 240.

The third party tracker 250 receives third party information from third party systems 120 and stores the received information in the third party data store 255, e.g., a computer database. The third party tracker 250 can periodically send a request for third party information to a third party system 120. The third party system 120 provides the third party information in response to receiving the request. Third party systems 120 can also provide third party information proactively to the third party tracker 250 without requiring a request. For example, a third party system 120 automatically provides third party information in response to a user performing an action on the third party system 120, for example, visiting a website of the third party system 120 or performing a keyword search using the third party system 120. As another example, a third party system 120 automatically provides third party information on a regular basis to the third party tracker 250, e.g., once every day, week, or month.

In one embodiment, the third party tracker 250 receives information from third party systems 120 using pixel tracking (or “pixel fire”). The online system 100 or another system provides a pixel to a third party system 120 to be included in a user interface associated with the third party system 120. The third party system 120 provides third party information to the third party tracker 250 in response to the client device 110 of a user of the online system 100 requesting the pixel of the user interface. For example, the pixel can be included in a user interface displaying a website of the third party system 120, e.g., a website for a check-out process for acquiring an item (e.g., a travel related product or service available via the third party system 120). The website may include information about the item such as the name, description, inventory, availability, price, and the like. In one embodiment, the item is a ticket for a flight and the information include the scheduled departure time and arrival time, the origin and destination airport locations, the type of seat (e.g., economy, business class, or first class), the cost of the ticket, and the third party providing the flight. In another embodiment, the item is a hotel booking and the information includes the check-in and check-out date and/or time, the type of room or suite (e.g., standard, queen, king, or luxury), the cost of the booking, and the third party providing the lodging.

When the client device 110 of the user parses the page of the website that refers to the pixel, the client device 110 executes code associated with the pixel that causes the client device 110 to interact with the online system 100. The interaction of the client device 110 with the online system 100 provides information describing the user interaction with the website to the online system 100. The information describing the user interaction may include third party information indicating that the user viewed the website. Additionally, the information describing the user interaction may describe a travel related service. In some embodiments, the third party tracker 250 can provide multiple pixels to the third party system 120. The multiple pixels can each be associated with the same travel related service or with a different travel related service.

The action filter 260 filters actions performed by users of the online system 100. In one embodiment, the action filter 260 receives a set of actions from the action log 220 and/or the third party data store 255. The actions are each associated with a corresponding timestamp (e.g., when the action was performed by a user) and/or geographical location. In other embodiments, the actions may be associated with other types of information (e.g., a future date range or another geographical location). The action filter 260 excludes at least one of the actions from the set based on one or more criteria. For example, criteria might indicate that the action filter 260 should exclude actions with an associated timestamp outside of a particular date range, or an associated geographical location outside of a particular geographical region, from the set (e.g., downtown San Francisco is located inside of the San Francisco Bay Area, but Hawaii is not and therefore actions related to Hawaii are excluded).

In other words, the criteria include inclusion rules and/or exclusion rules that indicate which types of actions should be included or excluded from the filtered set. Further, the criteria may include static and/or dynamic rules. For instance, the date range may be dynamic and change from a two-week range to a three-week range. As another example, the geographical location or a date of travel may be static, e.g., cannot be modified for a user's trip. The online system 100 may receive the rules from a third party system 120, e.g., the same third party that also provides content items or information for generating content items. Thus, the online system 100 can select and deliver content items to a target audience of users based on the preferences of the third party system 120. In some embodiments, content items with travel related information are specific to a geographical location and/or time, e.g., a planned date, departure time from an origin location, and arrival time at a destination location. For instance, a user searches for and views content items describing flights to Hawaii departing at various times of a given day (e.g., 8 AM, 10 AM, 12 PM, and 2 PM). Based on these actions of the user, the online system 100 determines that the user is likely intending to travel to Hawaii on the given day, and has not decided yet on a particular time for the flight.

In some embodiments, the rules engine 280 generates the inclusion rules and/or exclusion ruled based on information from third party systems 120. For instance, following in the example above, a third party system 120 provides flights to Hawaii and wants to provide content items to a target audience of users who are likely to travel to Hawaii. The third party system 120 may also indicate certain parameters for the target audience, e.g., users who have families with children, users traveling from California, users with a particular socioeconomic or education status, etc. Based on the indicated target audience of the third party system 120, the rules engine 280 generates rules and/or sub-rules to identify users who should be included in the target audience. The rules engine 280 may store rules in the third party data store 255 or any other database accessible to the online system 100.

The rules engine 280 can apply rules to user information when the online system 100 receives the user information, e.g., based on actions performed by users on the online system 100 or a third party system 120, in some embodiments. For instance, a user searches for flights to Hawaii on a website of an airline. A third party system 120 associated with the airline provides user information corresponding to the search for flights to the online system 100. The rules engine 280 applies a rule to the user information and determines that the user should be included in the target audience for flights to Hawaii. Thus, the rules engine 280 may generate and apply rules to determine whether a user should be included in a target audience in advance, e.g., before there is an opportunity to present a content item to the user. In some embodiments, the rules engine 280 can also apply rules to user information (or generate new rules or update existing rules) at runtime, e.g., when there is an opportunity to present a content item to the user.

In some embodiments, the machine learning engine 265 uses machine learning techniques to train one or more models for providing travel related content that is appropriate for the user. For example, a machine learning model can determine a likelihood that a user will travel to a certain geographical region. Further, a machine learning model can select content items including travel related content that are likely to be of interest to a user, thus increasing the likelihood that the user will interact with the content items.

Machine learning techniques include, for example, linear regression, decision trees, support vector machines, classifiers (e.g., a Naive Bayes classifier), and gradient boosting, boosting for other algorithms (e.g., AdaBoost), neural net, logistic regression, memory-based learning, random forests, bagged trees, boosted trees, boosted stumps, etc. The machine learning models can initially be trained by extracting features associated with travel related content and trips taken by users of the online system 100 for which certain information has already been determined and creating a feature vector. Dimensionality reduction (e.g., via linear discriminant analysis, principle component analysis, etc.) can be used to reduce the amount of data in the feature vector to a smaller, more representative core set of features. The training set for the machine learning model or classifiers that will be used is a subset of the overall data set that is representative of the data to be classified, including positive and negative examples on which the model is being trained. In supervised training, the training set items are labeled with the data that they are determined to represent. The training outputs models or classifiers that can then be used to identify this same data associated with other similar items that the model has not encountered before. The accuracy of the trained classifier is evaluated using a validation set that was formed as a disjoint set of the data for testing the trained classifiers to ensure the classifier generalizes to non-training data. Common metrics applied in accuracy measurement include: Precision=TP/(TP+FP) and Recall=TP/(TP+FN), where precision is how many the classifier correctly guessed (TP or true positives) out of the total it predicted (TP+FP or false positives) and recall is how many it correctly guessed (TP) out of the total that did represent the concept (TP+FN or false negatives). The F score (F-score=2*PR/(P+R)) unifies the two into one measure, and the system can reject or iterate on the model as needed based on the accuracy measurement result. Ultimately, the trained classifier is used to label unknown content items based on the same features being extracted from these unknown content items.

In one embodiment, the machine learning engine 265 trains the models using feature vectors and a training label. The feature vectors include information from various components of the online system 100 and/or third party systems 120. For example, the feature vectors can be derived from information about trips taken by a population of users of the online system 100. The information may be a string data type representation of an item description from a website of a third party system 120. The machine learning engine 265 derives feature vectors using information on the online system 100 or accessible to the online system 100. For example, the machine learning engine 265 may retrieve information from modules of the online system 100 such as the user profile store 200, action log 220, third party data store 255, content item store 275, etc., to derive feature vectors and/or determine training labels.

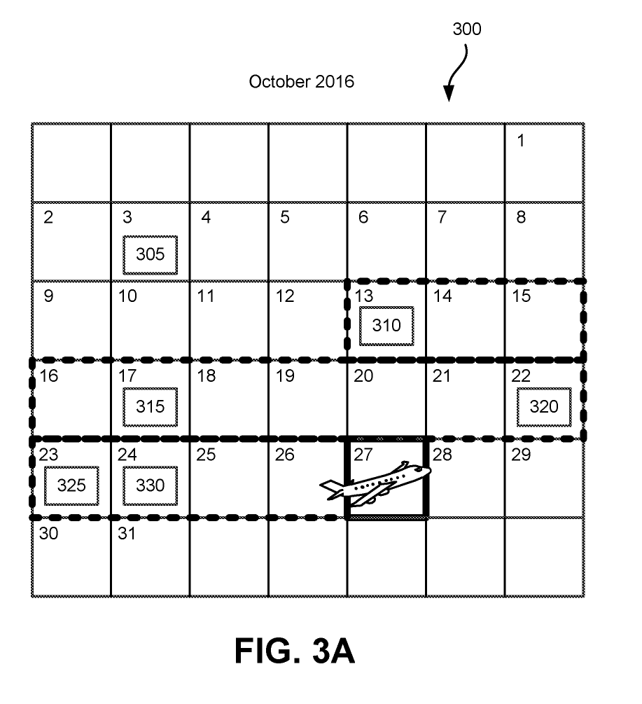

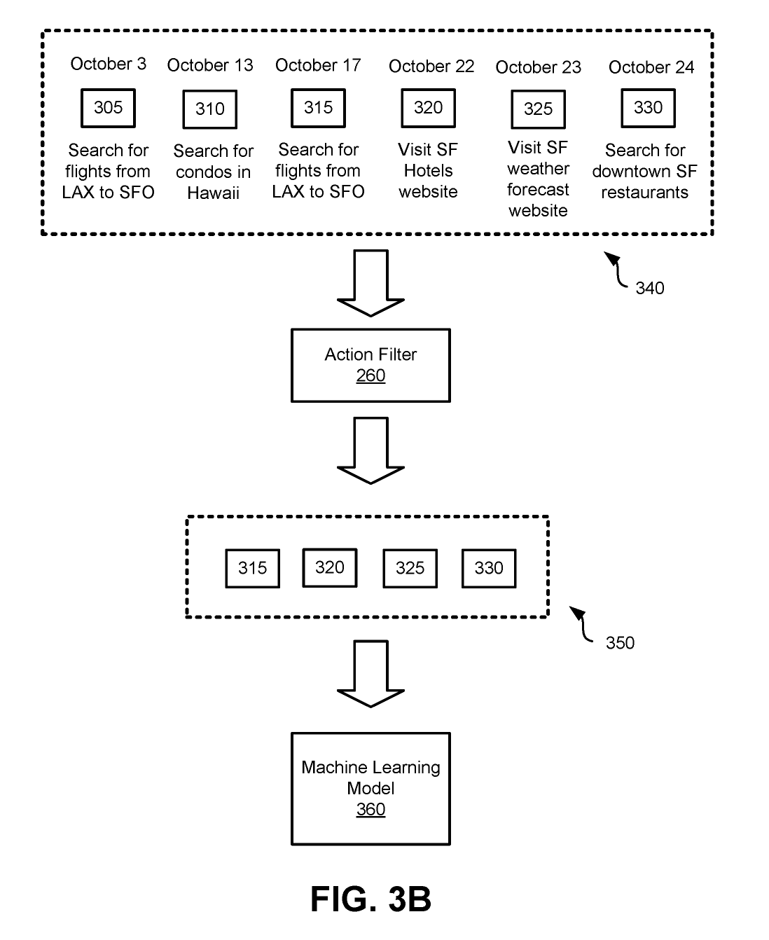

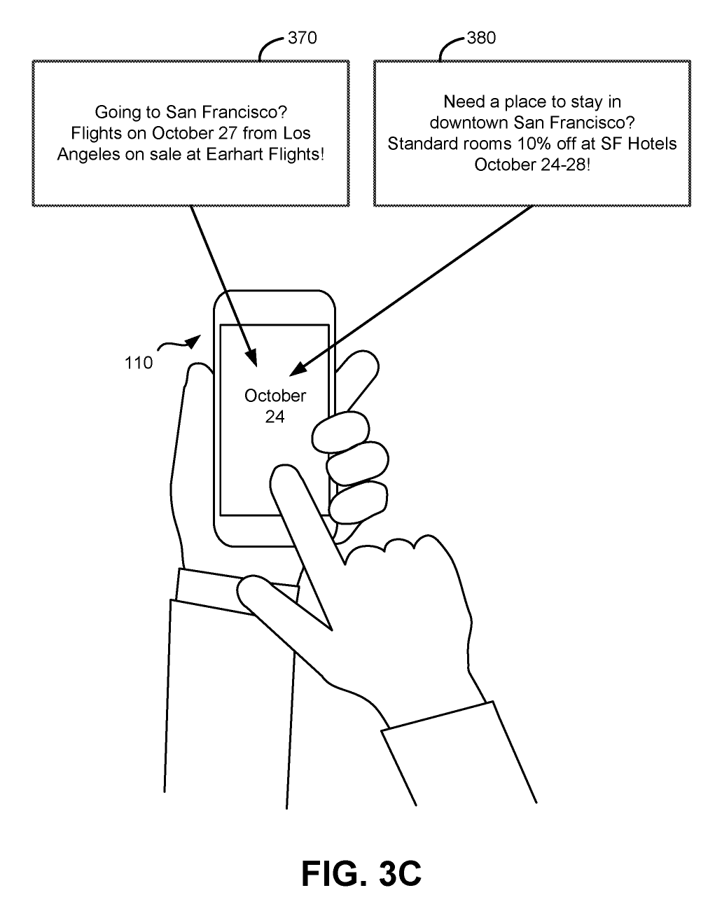

The training label indicates information that the machine learning model is trained to predict. For example, the training label could indicate whether a user went on a trip, booked a flight to or lodging at a particular geographical location, modified the trip's itinerary, etc. In some embodiments, the machine learning engine 265 uses the training labels to partition information into positive and negative training sets. For example, the machine learning engine 265 labels a training set as positive if the training set includes information indicating that a user searched for flight tickets, booked a flight, and took the flight for a trip. As another example, the machine learning engine 265 labels another training set as negative if the training set includes information indicating that a user searched for flight tickets, but did not book or take a flight for a trip. Example features used to train models are further described below with reference to FIG. 3B.

In some embodiments, the online system 100 can select content items using methods other than a machine learning model, e.g., selecting based on a database of rules and using the previously described rules engine 280. For example, a rule indicates that if a user views a content item describing flights to a particular location for at least a threshold number of times in a certain time period (e.g., viewed flights to Hawaii at least three times in the past month), the online system 100 determines that there is a high likelihood that the user intends to travel to Hawaii (e.g., within the next several months). The online system 100 may determine the likelihood of the user's travel intent based on the rules and the number of time the user viewed the content item, e.g., for each additional viewing of the content item, the online system 100 increases the determined likelihood by 5%.

The content engine 270 generates content items for presentation to users of the online system 100. The content engine 270 can analyze information stored in the user profile store 200 or action log 220 to identify information useful for generating content items. The content engine 270 may also obtain information from other run time modules that implement functionality for performing different types of actions. For example, if a user views a brand page of a third party system 120, the module executing the code for displaying the brand page to the user informs the content generator 290 of the action so that the content generator 290 can generate a content item describing the action. Further, the content engine 270 can generate content items based on information provided by a third party system 120, e.g., travel related information available via the third party system 120. The content engine 270 stores content items in the content item store 275 and may retrieve content items from the content item store 275, e.g., previously generated content items from the online system 100 or a third party system 120. In some embodiments, the content item is provided by a third party system 120 or is created on the online system 100 by the third party system 120. In some embodiments, the online system 100 dynamically adds at impression time certain data to the content item, such as information about current prices of services or information based on the user's travel itinerary.

In some embodiments, the content engine 270 can schedule a particular time or time range and deliver a content item to a client device 110 of a target user during the particular time or time range. The content engine 270 may determine the particular time or time range to schedule and/or deliver content items based on when the content engine 270 determines that the target user is likely to be interested in and interact with the content item. For instance, after the target user on a flight lands at an airport, there is a strong chance that the user will be interested in viewing content items describing available rental cars; therefore, the content engine 270 might schedule to deliver a content item describing available rental cars for delivery during some time range after the user's flight lands.

### III. Predicting Travel Intentions of a User

FIG. 3A is a diagram of a calendar 300 of a user's actions according to one embodiment. In the embodiment shown in FIG. 3A, the calendar 300 shows the days of the month of October 2016 and indicates on which days Sheryl performed actions on the online system 100 or a third party system 120. In particular, Sheryl performed actions 305, 310, 315, 320, 325, and 330 on October 3, October 13, October 17, October 22, October 23, and October 24, respectively. The calendar 300 also shows a target date in bold lines and a date range in dotted lines. In particular, the target date is October 27 and the date range is the two weeks preceding the target date (October 13 through 26). The target date may be associated with a trip such as a flight. The date range may be referred to as the “lead time” or “booking window” because the date range indicates the time leading up to the target date when a user may book a flight or hotel for a trip starting on the target date. Accordingly, a third party providing travel related products or services (e.g., transportation via vehicles such as automobiles or airplanes, or lodging such as a hotel or motel) may be interested in providing content items describing the products or services for display to users during the corresponding lead time.

FIG. 3B is a data flow diagram of filtering a user's actions according to one embodiment. FIG. 3B shows a set 340 of the six actions performed by Sheryl in October 2016 shown in FIG. 3A. Action 305 is a search for flights from LAX to SFO, action 310 is a search for condos in Hawaii, action 315 is a second search for flights from LAX to SFO, action 320 is a visit to a SF Hotels website, action 325 is a visit to a website including the San Francisco weather forecast, and action 330 is a search for restaurants in downtown San Francisco. Each action is associated with at least one geographical location and a timestamp indicating the date at which Sheryl performed the action. Actions 305, 315, 320, 325, and 330 are associated with the geographical location of San Francisco (the location of SFO airport) while action 310 is associated with the geographical location of Hawaii. Action 305 and 315 are each also associated with another geographical location (namely, Los Angeles, the location of the LAX airport). Actions with two more geographical locations may designate the geographical locations as an origin location or a destination location. For instance, action 315 designates Los Angeles as the origin location and designates San Francisco as the destination location.

Actions 305, 310, 315, 320, 325, and 330 are associated with timestamps of October 3, October 13, October 17, October 22, October 23, and October 24, respectively. In some embodiments, the timestamp may also include a particular time during the day as well as a time zone (e.g., Eastern Standard Time (EST), Central Standard Time (CST), Mountain Standard Time (MST), Pacific Standard Time (PST), a Coordinated Universal Time (UTC) offset, etc.).

In the embodiment shown in FIG. 3B, the action filter 260 excludes one or more actions from the set 340 that have a timestamp outside of a time range or that have a geographical location outside of a geographical region. Continuing the example of FIG. 3A, the time range is the date range of October 13 through 26, and the geographical region is the San Francisco Bay Area (e.g., including cities in the region such as San Francisco, Oakland, San Jose, Mountain View, etc.). The action filter 260 excludes action 305 from the filtered set 350 because the action 305 has a timestamp of October 3, which is outside the date range of October 13 through 26. Additionally, the action filter 260 excludes action 310 from the filtered set 350 because the action 310 has a geographical location of Hawaii, which is outside the geographical region of the San Francisco Bay Area. In some embodiments, the time range is provided by a third party system 120 to the online system 100.

The machine learning model 360 (trained by the machine learning engine 265) determines a likelihood that a user will travel to the San Francisco Bay Area geographical region based on the filtered set 350. The machine learning model 360 is trained using feature vectors including actions performed by other users of the online system 100.

For example, assume that a particular feature vector indicates that a user viewed websites including information associated with a particular geographical location, e.g., New York City, and that the user performed each of the actions (e.g., website views) during a time range of one week. The feature vector is associated with a training label indicating that the user traveled to New York City. Additionally, the feature vector includes information indicating that the user traveled to New York City on the day following the one week, e.g., because the online system 100 determined that the user traveled based on information from the user's hotel and/or flight booking from a third party system 120. For instance, hotel booking information could indicate that the hotel is located in New York City, and flight booking information could indicate that a plane's destination is JFK International Airport. Thus, the machine learning model 360 trained at least using the feature vector and training label learns that a user who views websites including information associated with a particular geographical location several times within a certain time range has a high likelihood of ultimately traveling to the particular geographical location, e.g., shortly after the certain time range. In other words, the machine learning model 360 predicts the travel intentions of the user. In some embodiments, the machine learning model 360 predicts the likelihood that the user will travel to the particular geographical location on a given date and/or time, e.g., proceeding the time range of the one week.

In contrast, a second example feature vector and training label might indicate that, within the certain time range, the user only visited one website including information associated with the particular geographical location and that the user did not travel to the particular geographical location in a period of time following the certain time range. Thus, the machine learning model 360 trained at least using the second feature vector learns that a user who views information associated with a particular geographical location only once within a certain time range has a low likelihood of traveling to the particular geographical location, e.g., shortly after the certain time range.

As another example, the machine learning model 360 learns from feature vectors that a user's actions of searching for flights or hotel rooms around (or on) a particular date indicate that the user likely has an intent to take a flight or stay at a hotel around the particular date. Thus, the machine learning model 360 can predict when a user is likely to take a trip even if the user has not yet booked flights and/or lodging.

In one embodiment, the online system 100 receives information indicating that a user has booked a lodging at a given location (e.g., made a reservation for a number of nights at a hotel), but has not yet booked transportation to the given location, and the machine learning engine 265 includes this information in a feature vector. For example, the information includes a Boolean variable indicating whether or not the user has booked lodging at, and has booked transportation to, the given location. The machine learning engine 265 trains the machine learning model 360 using the feature vector. Thus, for example at runtime, the previously trained machine learning model 360 determines that the user is likely to book transportation to the given location. Similarly, the machine learning engine 265 may include information in a feature vector indicating that the user has booked transportation to a given location (e.g., booked a flight, cruise ship ride, or bus ride on a certain date), but has not yet booked a lodging at the given location. Accordingly, the machine learning model 360 determines that the user is likely to book a lodging for the given location.

The machine learning model 360 can also learn based on feature vectors derived from content items that other users of the online system 100 interacted with and/or from actions performed by the other users, e.g., associated with trips taken by the users. In an embodiment, a feature vector includes information describing actions of users who frequently interacted with content items including information associated with a location (e.g., content items describing popular tourist destinations and recreational activities at the location). A training label of the feature vector indicates that the users searched for flights to and/or hotels are the location. For instance, users who interacted with content items describing snorkeling and Hawaiian barbeque restaurants nearby Waikiki Beach also searched for flights into Honolulu International Airport in Hawaii. In other words, the model trained using the feature vector with the training label can infer a user's travel intent based on the user's interactions with content items including relevant content. The relevant content may also describe rental cars, public transportation, celebrities, weather and traffic conditions, or other entertainment available in Hawaii.

Feature vectors may include demographic information of the users of the online system 100, e.g., retrieved from the user profile store 200. For example, the feature vectors and associated training labels indicate that a majority of the users who searched for flights to Hawaii are within the 30-40 year old range, or that users located in California have a high likelihood of traveling to Hawaii for vacations around holidays such as Christmas or during the summer. As another example, the feature vectors may indicate that users in the 50-70 year old range frequently searched for flights or lodging in Florida. As yet another example, the feature vectors may indicate that users in the 20-30 year old range are more likely to book lodging at hostels or through home-sharing services than users in the 30-40 year old range, e.g., who are more likely to book lodging at hotels instead.

Continuing in the example from one embodiment, the machine learning model 360 determines that there is a high likelihood that the Sheryl will travel to the San Francisco Bay Area geographical region based on the filtered set 350. In particular, the actions of the filtered set 350 indicate that Sheryl has a high level of interest in viewing information associated with the San Francisco Bay Area, e.g., hotels, weather, and restaurants in the area. Additionally, the actions of the filtered set 350 are performed within a time range of two weeks, and actions 320, 325, and 330 are performed on three consecutive days. The machine learning model 360 learns from feature vectors and training labels that a higher frequency of actions within a time range, especially leading up to a potential target date, is correlated with a stronger intent of the user to take a trip associated with information describing the actions (e.g., traveling to San Francisco).

FIG. 3C shows example travel related content items provided before a user's trip according to one embodiment. The content item 370 indicates that flights from Earhart Flights are on sale on October 27, and the content item 380 indicates that standard rooms at SF Hotels are 10% off from October 24-28. The content engine 270 may generate the content items 370 and 380 based on information provided by Earhart Flights and SF Hotels (e.g., third party systems 120), respectively. The content item 370 is associated with the location of San Francisco (e.g., SFO as the destination airport) and Los Angeles (e.g., LAX as the departure airport). The content item 380 is associated with the location of San Francisco, or in particular, downtown San Francisco. Content items may be associated with a date and/or time, e.g., October 27 for content item 370 or with a time range (two or more dates), e.g., October 24-28 for content item 380.

The machine learning model 360 described in FIG. 3B selects the content items 370 and/or 380 based on the determination that the Sheryl has a high likelihood of traveling to the San Francisco Bay Area geographical region. In particular, the machine learning model 360 selects the content item 370 because Sheryl is predicted to need transportation from her home in Los Angeles to San Francisco. The machine learning model 360 selects the content item 380 because Sheryl is predicted to need a place to stay while she is in San Francisco. The machine learning model 360 specifically selects a hotel in downtown San Francisco (as opposed to another part of the San Francisco Bay Area) because one of Sheryl's actions was searching for restaurants in downtown San Francisco (based on action 330 shown in FIG. 3B). The third parties, Earhart Flights and SF Hotels, each have offers that overlap with the days that Sheryl is planning to travel. The content engine 270 delivers the content items 370 and/or 380 to Sheryl's client device 110 on October 24 because October 24 is in the lead time before the target travel date of October 27, and Sheryl will likely want to book a flight and hotel before she travels to San Francisco.

### IV. Providing Content Items During a Trip

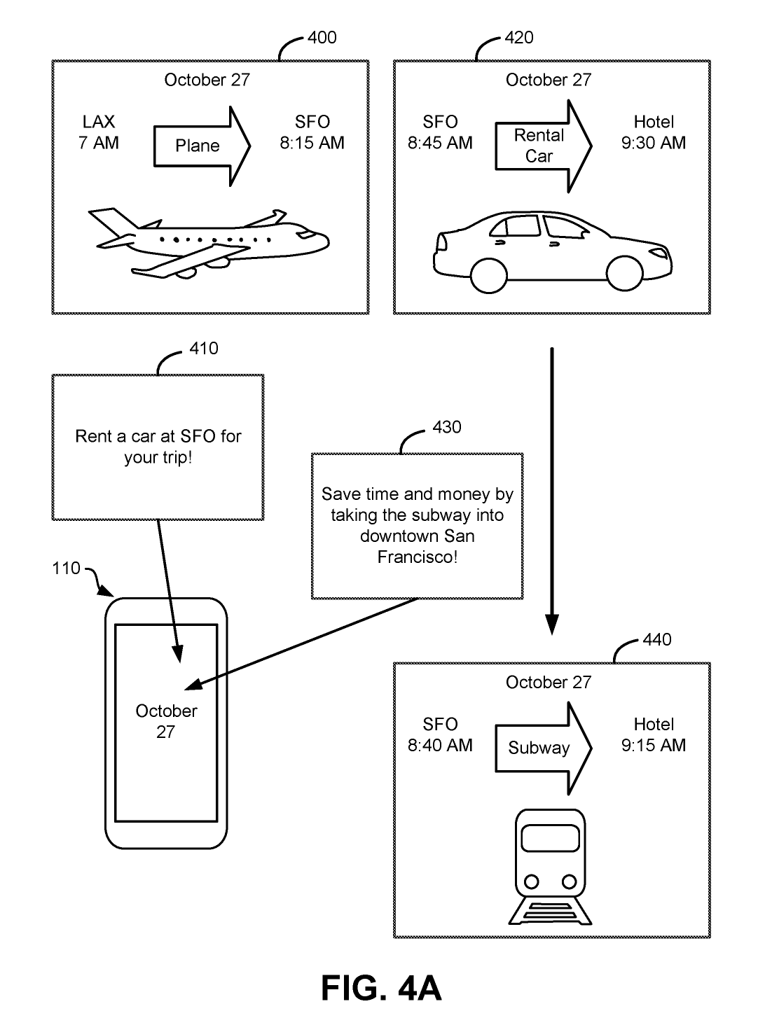

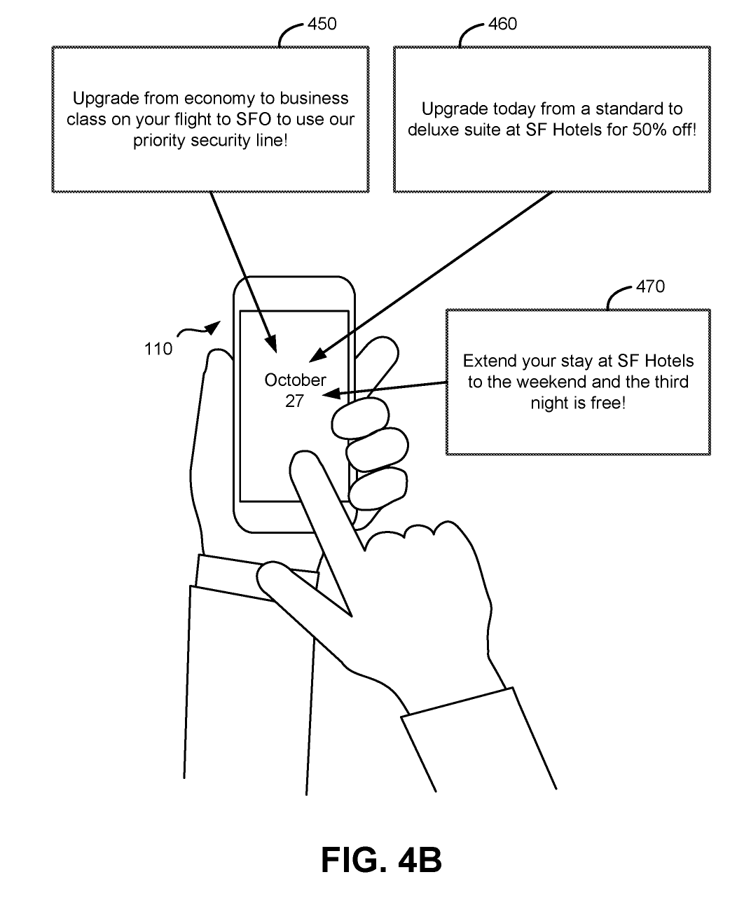

FIG. 4A shows example travel related content items provided during a user's trip according to one embodiment. In an embodiment, the online system 100 determines itinerary information about a trip that Sheryl is taking based on actions performed by Sheryl on the online system 100 or a third party system 120. The itinerary information indicates that Sheryl booked a flight 400 with Earhart Flights on October 27 departing from LAX at 7 AM and arriving at SFO at 8:15 AM, and that Sheryl booked a standard suite at SF Hotels for the night of October 27. The itinerary information for a trip may include multiple sub-trips or legs of the trip. For example, a user could take a first vehicle for a first sub-trip and could take a second vehicle for a second sub-trip. The vehicle may be any suitable vehicle for transporting people via land (e.g., automobiles, cars, trucks, motorcycles, trains, trolleys, light rails, etc.), air (e.g., airplanes, helicopters, etc.), and/or sea (e.g., ships, boats, ferries, etc.). The first and second vehicles may be the same or different type of vehicle. For example, the first vehicle could be an airplane and the second vehicle could be a car.

In one embodiment, the machine learning engine 265 trains a machine learning model to select the travel related content items to be delivered to Sheryl's client device 110 during her trip. The machine learning model is trained using feature vectors including information from trips taken by other users of the online system 100, e.g., who have similar characteristics to Sheryl (e.g., based on information from the user profile store 200, action log 220, or third party data store 255). For instance, in one embodiment the characteristics are based on demographic information, e.g., the other users are also female users in the 20-30 year old age range and located in California, or are from the same college or professional network. As another example, the characteristics are based on user affinities, e.g., Sheryl commented, liked, or shared similar content on the online system 100 as the other users. For instance, Sheryl and another user both interacted with a brand page of a sports team on the online system 100.

As an example, a feature vector and training label indicates that the other users similar to Sheryl often rent a car when traveling. The machine learning engine 265 derives the feature vector based on user information of Sheryl and the itinerary information. The machine learning engine 265 provides the feature vector as input to machine learning model 360. The machine learning model 360 trained at least using the feature vector selects the content item 410, which includes a message suggesting that Sheryl should rent a car at SFO for her trip, based on the inputs. Additionally, the feature vector and training label may indicate which car models and makes are popular among users similar to Sheryl. For instance, 20-30 year old females might be interested in fuel efficient compact-sized cars. In contrast, users who are parents with children may be more interested in rental cars that are minivans or SUVs because these types of cars can fit more people. Thus, the machine learning model can select content items that are customized to offer a particular type of rental car that Sheryl is likely to be more interested in booking.

The machine learning model can also use exclusion rules to select content items. In one embodiment, the machine learning model excludes a content item from being selected if the content engine 270 previously presented the content item and/or a similar content item to a user. For example, if the user has already booked a rental car, then the machine learning model excludes any additional content items describing rental car bookings (except for possible upgrades to the user's existing rental car booking) from being selected because the user likely needs to rent no more than one car for a trip.

Continuing the example above, the content engine 270 delivers the selected content item 410 to Sheryl's client device 110 before she departs from SFO airport. Once Sheryl departs SFO, she will no longer need transportation from SFO because the online system 100 presumes that she has already found transportation arrangements. The content engine 270 can deliver the selected content item 410 to the client device 110 before Sheryl departs LAX on her flight, during Sheryl's flight (e.g., if the client device 110 can connect to the internet on a WIFI enabled plane), or within a period of time (e.g., one or two hours) immediately following Sheryl's arrival at SFO.

In one embodiment, the content engine 270 determines whether a user is about to depart from an origin location, has arrived at a destination location, or is currently traveling from the origin to the destination based on geographical data, e.g., from a global positioning system (GPS) co-processor of the user's client device 110. The content engine 270 may also determine the user's travel status based on a scheduled departure and arrival times for a flight, e.g., based on information of a flight ticket from the third party data store 255. The online system 100 may use other methods to determine the user's travel status, e.g., when the user's client device 110 is within a range of a BLUETOOTH® beacon at an airport, in one embodiment the client device 110 provides information to the online system 100 indicating that the user is located at the airport. Additionally, the online system 100 may receive information indicating the current (or recent) location or travel of a user from a third party system 120.

In some instances, the time zone of the origin location is different than the time zone of the destination location. Accordingly, the online system 100 may account for this difference based on the time zone of the location where the user is currently located, e.g., to determine the availability of transportation or lodging or to determine a date and/or time to deliver content items.

In one embodiment, in response to viewing the content item 410 on her client device 110, Sheryl decides that she wants to book a rental car, and thus Sheryl interacts with the content item 410. The online system 100 receives information from the client device 110 indicating Sheryl's intent to book the rental car. The online system 100 can provide a request (e.g., using an API) to a third party system 120 that offers rental cars at SFO. The request includes user information of Sheryl (e.g., age, name, billing information, car insurance data, or driver license data) and information describing a rental car booking (e.g., pick-up and return date and time, cost per day of rental, or type of car). Further, the online system 100 may receive authorization from Sheryl via her client device 110 to provide compensation to the third party system 120 for providing the rental car. The online system 100 can also modify the itinerary information of Sheryl's trip based on the request, e.g., to add a rental car booking to her trip.

As a different example, assume that the itinerary information indicates that Sheryl booked a rental car 420 in advance of her trip that is available at SFO at 8:45 AM on October 27. Thus, Sheryl can take the rental car 420 from the airport to her hotel in downtown San Francisco. A feature vector and training label indicate that the users who arrive at SFO airport and are traveling to downtown San Francisco often take the Bay Area Rapid Transit (BART) subway 440 (e.g., because the subway fare is less than the cost of a rental car). Additionally, the estimated time of arrival at the hotel is earlier if Sheryl takes the subway 440 as opposed to a rental car 420, e.g., due to traffic into downtown San Francisco. In some embodiments, the online system 100 uses GPS data or data from a third party system 120 (e.g., an application that provides traffic information) to determine which transportation option has the shortest travel time or earliest estimated arrival time at a given destination. A machine learning model 360 trained using the feature vector (e.g., along with a set of many other feature vectors) selects content item 430, which includes a message indicating that Sheryl can save time and money by taking the subway 440 into downtown San Francisco.

In one embodiment, in response to viewing the content item 430 on her client device 110, Sheryl decides that she wants to take the subway instead of renting a car, and thus Sheryl interacts with the content item 430. The online system 100 receives information from the client device 110 indicating Sheryl's intent to switch from the rental car to subway. The online system 100 can provide a request (e.g., using an API) to a third party system 120 through which Sheryl booked the rental car to cancel the rental car booking and/or to authorize any appropriate refund of the cost of the booking. Further, the online system 100 may display—or provide a universal resource link (URL) to—a schedule, a system map, ticket information, or any other information of the subway. The online system 100 can also modify the itinerary information of Sheryl's trip based on the request, e.g., to remove the rental car booking from her trip and add information about one or more subway trips that Sheryl can take downtown.

In some embodiments, the machine learning model selects a content item associated with an additional vehicle for a user's trip based on availability of the additional vehicle at a given geographical location. In particular, if a user is traveling in a first leg of a trip to the given geographical location, the additional vehicle for a second leg of the trip should also be available at the given geographical location for the user's convenience. For example, rental cars and a subway station are located at the SFO airport. Further, the time during which the additional vehicle is available should be within a predetermined period of time following the user's arrival time at the given geographical location. For example, the rental car or subway trip should be available within 30 minutes or one hour from the arrival time so that the user does not need to wait a long duration of time to transition from the first leg of the trip to the second leg of the trip. Accordingly, the machine learning model removes from consideration content items that are not available at the given geographical location during the predetermined period of time.

FIG. 4B shows example travel related content items provided during a user's trip to modify the user's trip according to one embodiment. The machine learning model previously described with reference to FIG. 4A (or a different machine learning model trained by the machine learning engine 265) can also select the travel related content items 450, 460, and 470 shown in FIG. 4B.

As one example, a feature vector and training label might indicate that users who frequently travel for business between the LAX and SFO airports and who have interacted with a brand page of Earhart Flights are likely to fly business class instead of economy class with Earhart Flights. The machine learning engine 265 retrieves user information of Sheryl from the action log 220 indicating that Sheryl liked a brand page of Earhart Flights on the online system 100. The user information also indicates that Sheryl frequently takes business trips based on information in her comments or posts on the online system 100. For example, the online system 100 determines that Sheryl frequently checks in at the LAX and SFO airport locations on weekdays. The machine learning engine 265 derives feature vectors using the user information and itinerary information, indicating that Sheryl is planning a trip from LAX to SFO on economy class. The machine learning engine 265 provides the feature vectors as input to the machine learning model for training.

Continuing the example, the machine learning model might determine that Sheryl is likely to want to upgrade from economy to business class for her upcoming flight, and if so, the machine learning model selects content item 450, which includes a message indicating that Sheryl can use a priority security line by upgrading to business class. In one embodiment, the content engine 270 delivers the selected content item 450 to Sheryl's client device 110 when she is waiting in a regular security line at the LAX airport because there is a greater chance that Sheryl will want to upgrade to business class if she can save time by using the priority security line, which is likely faster than the regular security line. The online system 100 may determine (or infer) that Sheryl arrived or is located at the airport based on GPS data from Sheryl's client device 110 or based on itinerary information, e.g., indicating a departure time of Sheryl's flight.

In other embodiments, content items can describe any type of modification of a seat on the airplane associated with a user's flight ticket. For example, the modification could be an upgrade from an economy, coach, or travel class seat to a business or first class seat. The online system 100 may receive authorization from a client device 110 of the user to provide compensation to a third party system 120 providing the flight ticket or airplane, e.g., the compensation is based on the difference in cost of an economy and business class seat for the flight.

As another example, assume that a feature vector and training label indicate that users who frequently fly business class—or have upgraded from economy to business class seats—are likely to book deluxe suites at hotels, relative to users who fly economy class. The machine learning engine 265 retrieves user information of Sheryl from the third party data store 255 indicating that Sheryl booked a business class flight. The machine learning engine 265 provides the user information and itinerary information, indicating that Sheryl has a standard suite booked at SF Hotels, as inputs to the machine learning model trained using the feature vector and training label. The machine learning model determines that Sheryl is likely to upgrade from the standard suite to a deluxe suite for her upcoming stay at SF hotels, so the machine learning model selects content item 460, which includes a message indicating that Sheryl can upgrade on the current day to a deluxe suite and take advantage of a 50% discount (an incentive). In other embodiments, an upgrade of lodging may be based on the size of a room or suite (e.g., floor space in square meters), the number or type of beds (e.g., roll-away, futon, twin, queen, or king size beds) in the room, view available from the room (e.g., interior, exterior, or waterfront view), various types of incentives (e.g., free breakfast and drinks, discounts or free tickets to local events such as sporting games and concerts), among other factors.

In one embodiment, the content engine 270 delivers the selected content item 460 to Sheryl's client device 110 after she has arrived at SFO or is traveling downtown to the hotel in downtown San Francisco. For example, based on GPS data from the client device 110, the online system 100 determines that Sheryl is within a predetermined distance from the hotel. In response to the determination, the content engine 270 delivers the selected content item 460. In another embodiment, the content engine 270 may provide the selected content item 460 after the online system 100 receives information indicating that Sheryl upgraded a seat on her flight to the SFO, e.g., from economy to business class, or indicating that Sheryl booked a rental car, e.g., a premium type rental car such as a convertible, SUV, or sports car.

As yet another example, a feature vector and training label indicate that users who travel business class on a Thursday frequently extend their stay to the weekend. The machine learning engine 265 provides itinerary information indicating that Sheryl booked a business class flight arriving in SFO on Thursday, October 27, as input to the machine learning model trained using the feature vector. The machine learning model determines that Sheryl is likely to extend her upcoming stay at SF hotels, so the machine learning model selects content item 470, which includes a message indicating that Sheryl can extend her stay to the weekend (e.g., to Saturday October 29 or Sunday October 30) and receive the third night stay for free. In other embodiments, the feature vector indicates that users tend to extend their stay for additional days around holidays.

In some embodiments, the machine learning model can select content items associated with other types of modifications of a user's trip. For example, the machine learning engine 265 retrieves user information of Sheryl from the action log 220 or third party data store 255 indicating that Sheryl searched for restaurants in downtown San Francisco or joined a fan group of a sports team (e.g., based in San Francisco, Oakland, or another nearby city). The machine learning engine 265 derives feature vectors based on the user information and itinerary information of Sheryl's trip. The machine learning engine 265 provides the feature vectors as inputs to the machine learning model. Thus, the machine learning model may select a content item describing new dishes of a restaurant in downtown San Francisco, e.g., a restaurant that is frequently patronized by travelers to San Francisco. Additionally, the machine learning model may select a content item describing tickets available for a game of the sports team on October 28 because the itinerary information indicates that Sheryl will be in the San Francisco Bay Area at least on October 28 and the user information indicates that Sheryl expressed interest in the sports team (e.g., by joining the fan group).

### V. Loyalty Programs

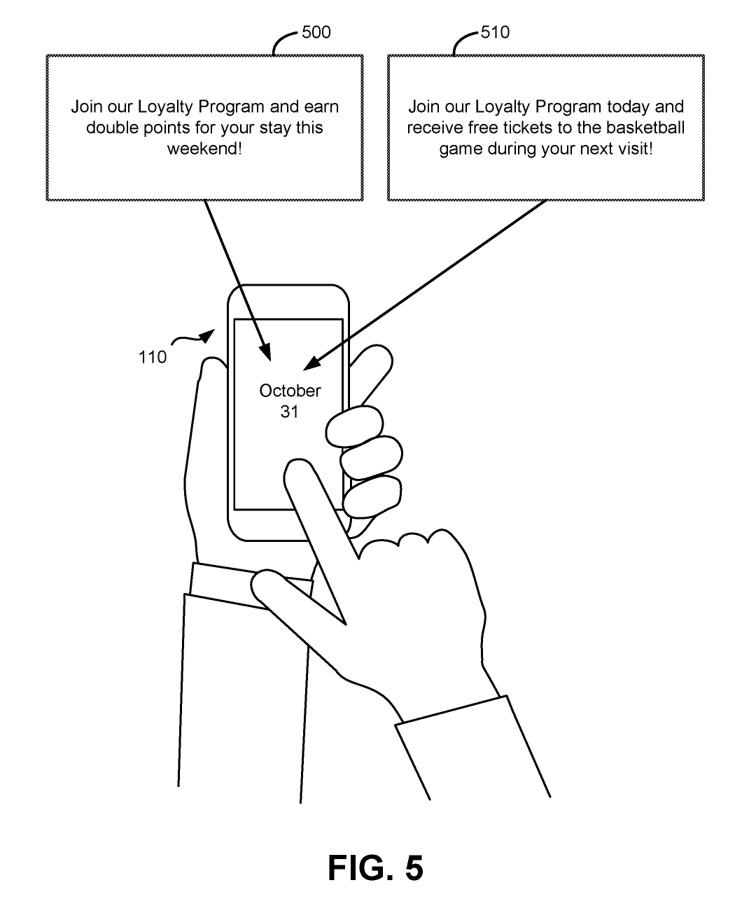

FIG. 5 shows example travel related content items associated with a loyalty program according to one embodiment. A loyalty program is associated with a third party system 120 and corresponding third party, e.g., Earhart Flights or SF Hotels. The third party system 120 can maintain a list of users who are included in the loyalty program and may add, edit, or remove users from the list at any time. The machine learning model previously described with reference to FIGS. 4A-B (or a different machine learning model trained by the machine learning engine 265) can also select the travel related content items 500 and 510 shown in FIG. 5 based on its prior training on feature vectors.

The machine learning engine 265 may derive feature vectors using itinerary information of trips taken by a population of users of the online system 100. The itinerary information may indicate a date on which one of the users checked out of a hotel that the user stayed at for the corresponding trip; the date may be used as a feature for training a model. The machine learning engine 265 may generates feature vectors based on itinerary information of trips having a recent check out date, in particular, within a predetermined period of time after a check out date of a given user such as Sheryl.

As one example in one embodiment, one feature in the feature vector is derived based on a number of users who are connected to Sheryl on the online system 100. For instance, the users are friends, family members, or indirect connections to Sheryl based on data from the user profile store 200. The machine learning engine 265 associates the feature vector in a positive training set if the number of users connected to Sheryl who are included in a loyalty program is above a threshold value. A machine learning model trained at least using the feature vector determines that there is a high likelihood that Sheryl will also want to be included in the same loyalty program, e.g., because the model infers that Sheryl will likely perform the same (or similar) actions as those of her connections on the online system 100. Thus, based on the likelihood, the machine learning model selects the content item 500 indicating that Sheryl can earn double points for her weekend stay at SF Hotels by joining a loyalty program associated with SF Hotels.

As another example, the machine learning engine 265 derives a feature vector based on information indicating that Sheryl's connections joined the loyalty program in response to viewing a content item with a similar (or same) incentive, e.g., earning points associated with the loyalty program, which can be credited towards future stays at SF Hotels. Additionally, the feature vector may be based on the number of nights that Sheryl's connections stayed at SF Hotels for past trips. Thus, a machine learning model trained using at least the feature vector may learn to predict that users who stay at the hotel greater than a threshold number of nights are more likely to want to join the loyalty program to earn points.

As another example, a feature vector and training label indicate that users who are included in the SF Hotels loyalty program are fans of a local basketball team or joined the loyalty program in response to receiving an incentive associated with the basketball team. Further, the machine learning engine 265 derives the feature vector based on information indicating that Sheryl is a fan of the basketball team, e.g., based on data from the user profile store 200, action log 220, and/or third party data store 255. Thus, a machine learning model trained using at least the feature vector predicts that Sheryl will likely wants to join the loyalty program to receive free tickets to a game of the basketball team during her next visit to San Francisco. Accordingly, the machine learning model selects the content item 510, and the content engine 270 delivers the content item 510 to Sheryl's client device 110. In other embodiments, the feature vector may be derived based on other characteristics that Sheryl and the users included in the loyalty program have in common, e.g., based on affinities, demographic data, geographical location, or socioeconomic status.

In one embodiment, the online system 100 receives information from Sheryl's client device 110 indicating that she wants to join the loyalty program and receive the incentive indicated by the corresponding content item (e.g., double points or free basketball game tickets). The online system 100 may provide information to the third party system 120 associated with the loyalty program indicating that Sheryl wants to join the loyalty program. The information may include user information about Sheryl from the user profile store 200 or action log 220 such as demographic data of Sheryl or actions that she performed on the online system 100. In response to receiving the information, the third party system 120 may add Sheryl to the loyalty program.

In one embodiment, the content engine 270 delivers the content item 500 and/or 510 to Sheryl's client device 110 in response to the online system 100 receiving information indicating that Sheryl has completed a portion of her trip, e.g., checking out of the hotel, or arriving or departing from an airport. For example, a third party system 120 of SF Hotels provides the check-out information to the online system 100 via an API when a front desk staff at Sheryl's hotel checks out Sheryl on October 31 using on online reservation computer system. The content engine 270 may deliver content items within a predetermined period of time following a user's check-out date or time, e.g., because the user may become less interested in—or forget about—the loyalty program as time progresses.

### VI. Example Process Flows

VI. A. Predicting Travel Intent

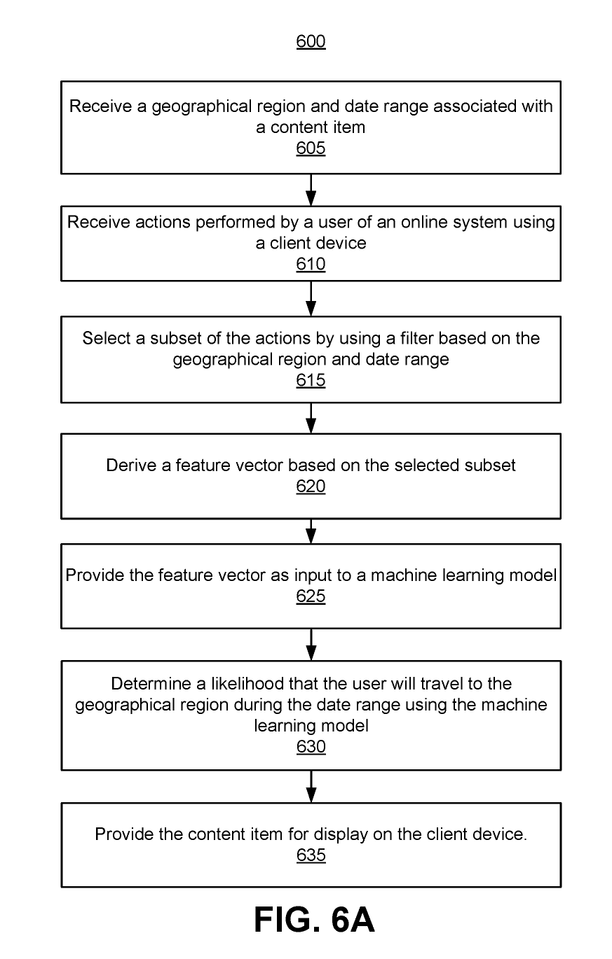

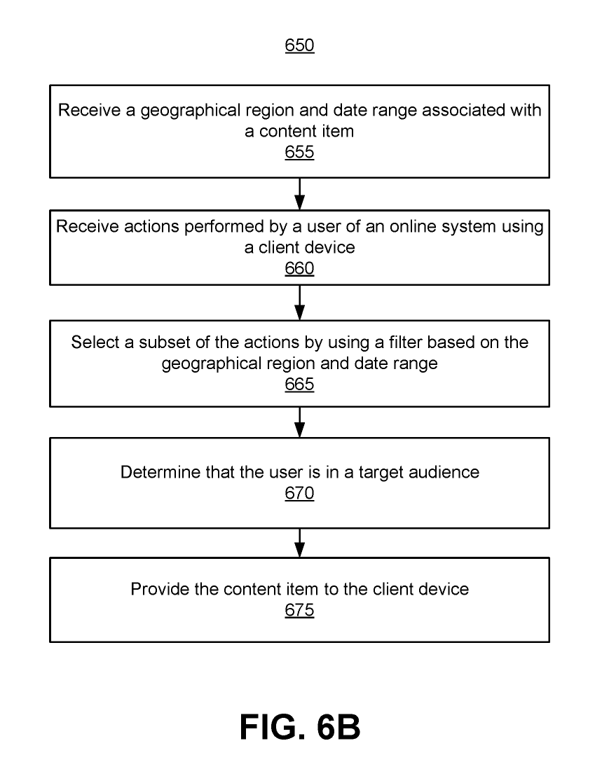

FIG. 6A is a flowchart illustrating a process 600 for providing a travel related content item before a user's trip according to one embodiment. In some embodiments, the process 600 is used by the online system 100—e.g., modules of the online system 100 described with reference to FIG. 2—within the system environment in FIG. 1. The process 600 may include different or additional steps than those described in conjunction with FIG. 6A in some embodiments or perform steps in different orders than the order described in conjunction with FIG. 6A.

In one embodiment, the online system 100 receives 605 information about a content item for display to users of the online system 100 with an intent to travel. The information may be received from a third party system 120 and include a geographical region and date range associated with a content item. For example, the content item describes flights to Hawaii and the date range is the past two weeks. The third party system 120 may specify the date range, with indicates a booking window up until a travel date.

The online system 100 receives 610 actions performed by a user of the online system 100 using a client device 110. The online system 100 may receive the actions from third party computer servers of a third party system 120. The actions may each be associated with a geographical location and a timestamp, e.g., the user performed several online searches for flights to both Hawaii and New York, where each search was performed on a date within the past month. The action filter 260 selects 615 a subset of the actions by using a filter based on the geographical region and date range. In one embodiment, the filter excludes at least one of the actions having a timestamp outside of the date range or a geographical location outside of the geographical region. For example, the flights to New York are excluded if the geographical region is Hawaii.

The machine learning engine 265 derives 620 a feature vector based on the selected subset of the actions. The machine learning engine 265 provides 625 the feature vector as input to a machine learning model. The online system 100 determines 630, for example, using the machine learning model based on the feature vector, a likelihood that the user will travel to the geographical region during the date range. For example, if the user searched for flights, hotels, and rental cars at Hawaii and the user's friends (e.g., based on connections on the online system 100) also traveled to Hawaii during the past two months, the machine learning model predicts that there is a high likelihood that the user will also travel to Hawaii. The content engine 270 provides 635 the content item for display on the client device 110 in response to the likelihood being greater than a threshold value. The content engine 270 may provide the content item within the booking window before the user travels to the geographical location, e.g., so that the user can book a flight to the geographical location using the online system 100.

FIG. 6B is a flowchart illustrating another process 650 for providing a travel related content item before a user's trip according to one embodiment. In some embodiments, the process 650 is used by the online system 100—e.g., modules of the online system 100 described with reference to FIG. 2—within the system environment in FIG. 1. The process 650 may include different or additional steps than those described in conjunction with FIG. 6B in some embodiments or perform steps in different orders than the order described in conjunction with FIG. 6B.

In one embodiment, the online system 100 receives 655 information about a content item for display to users of the online system 100 with an intent to travel. The information may be received from a third party system 120 and include a geographical region and date range associated with a content item. The third party system 120 may specify the date range, with indicates a booking window up until a travel date.

The online system 100 receives 660 actions performed by a user of the online system 100 using a client device 110. The actions may each be associated with a geographical location and a timestamp. The action filter 260 selects 665 a subset of the actions by using a filter based on the geographical region and date range. In one embodiment, the filter excludes at least one of the actions having a timestamp outside of the date range or a geographical location outside of the geographical region.

The rules engine 280 determines 670 that the user is in a target audience associated with the content item based on the selected subset. The rules engine 280 may apply one or more rules using information about the actions of the selected subset. For instance, a rule indicates that the user should be included in the target audience if the user searched for flights or lodging at the geographical region associated with the content item. In response to determining that the user is in the target audience, the content engine 270 provides 675 within the booking window before the user travels to the geographical region, the content item to the client device of the user.

VI. B. Modifying Travel Itineraries

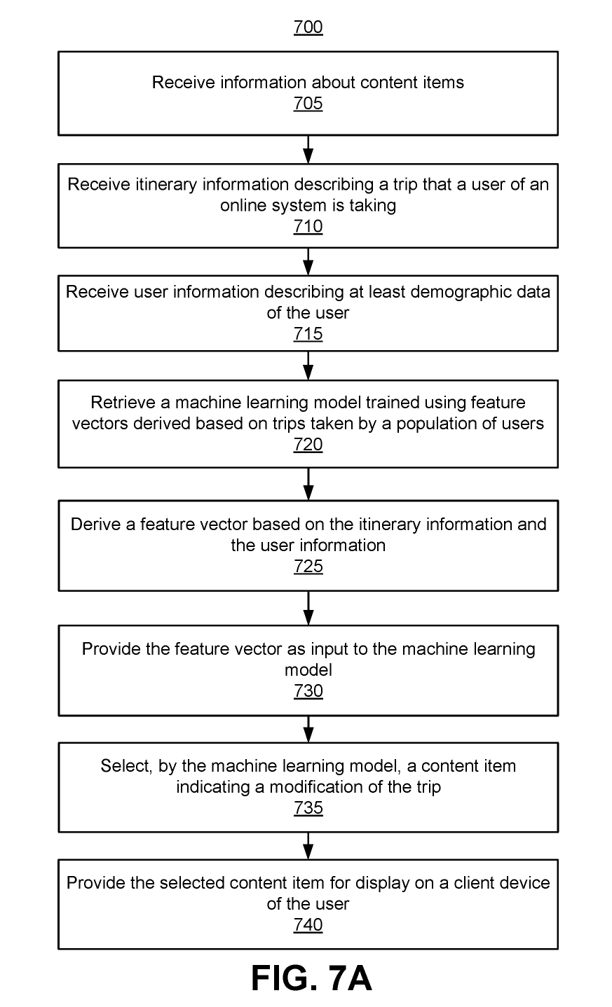

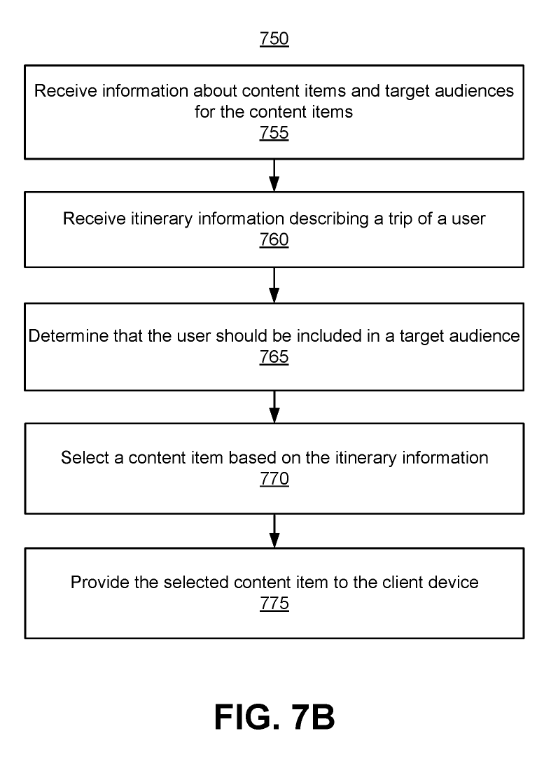

FIG. 7A is a flowchart illustrating a process 700 for providing a travel related content item during a user's trip according to one embodiment. In some embodiments, the process 700 is used by the online system 100—e.g., modules of the online system 100 described with reference to FIG. 2—within the system environment in FIG. 1. The process 700 may include different or additional steps than those described in conjunction with FIG. 7A in some embodiments or perform steps in different orders than the order described in conjunction with FIG. 7A.

In one embodiment, the online system 100 receives 705, from third party systems 120, information about a set of content items for display to users of the online system with a travel itinerary. The information may define target audiences for the set of content items. The online system 100 receives 710, from the third party systems 120, itinerary information describing a trip that a user of the online system 100 is taking. The trip may be associated with a vehicle and have a departure time and an arrival time at a geographical location, e.g., the user is traveling by airplane to Hawaii. The online system 100 receives 715 user information describing at least demographic data of the user.

The machine learning engine 265 retrieves 720 a machine learning model trained using feature vectors derived based on trips taken by a population of users, e.g., who have previously traveled by airplane to Hawaii. The machine learning engine 265 derives 725 a feature vector based on the itinerary information and the user information. The machine learning engine 265 provides 730 the feature vector as input to the machine learning model. The machine learning model selects 735 a content item of the set of content items indicating a modification of the trip associated with at least one of the vehicle or the geographical location. For example, the modification is a seat upgrade from economy class to business class on the airplane, or a hotel room upgrade from a standard suite to a deluxe suite. The content engine 270 provides 740 the selected content item for display on a client device 110 of the user, for example, before the departure time or within a period of time following the arrival time.

FIG. 7B is a flowchart illustrating another process 750 for providing a travel related content item during a user's trip according to one embodiment. In some embodiments, the process 750 is used by the online system 100—e.g., modules of the online system 100 described with reference to FIG. 2—within the system environment in FIG. 1. The process 750 may include different or additional steps than those described in conjunction with FIG. 7B in some embodiments or perform steps in different orders than the order described in conjunction with FIG. 7B.

In one embodiment, the online system 100 receives 755, from third party systems 120, information about a set of content items for display to users of the online system 100 with a travel itinerary. The information may define a set of target audiences for the set of content items. The online system 100 receives 760, from the third party systems 120, itinerary information describing a trip that a user of the online system 100 is taking. The trip may be associated with a vehicle and have a departure time and an arrival time at a geographical location. The rules engine 280 determines 765 that the user should be included in a target audience of the set of target audiences. In response to determining that the user should be included in the target audience, the content engine 270 selects 770 a content item of the set of content items based on the itinerary information. The selected content item indicates a modification of the trip associated with at least one of the vehicle or the geographical location. The content engine 270 provides 775, before the departure time or before a period of time following the arrival time, the selected content item to a client device 110 of the user.

VI. C. Itineraries with Multiple Trips and Vehicles

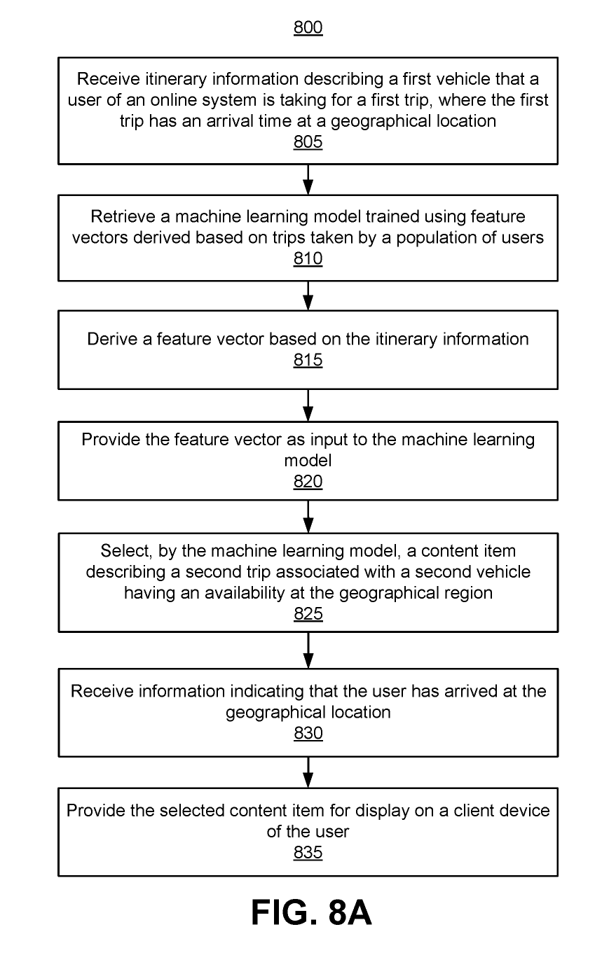

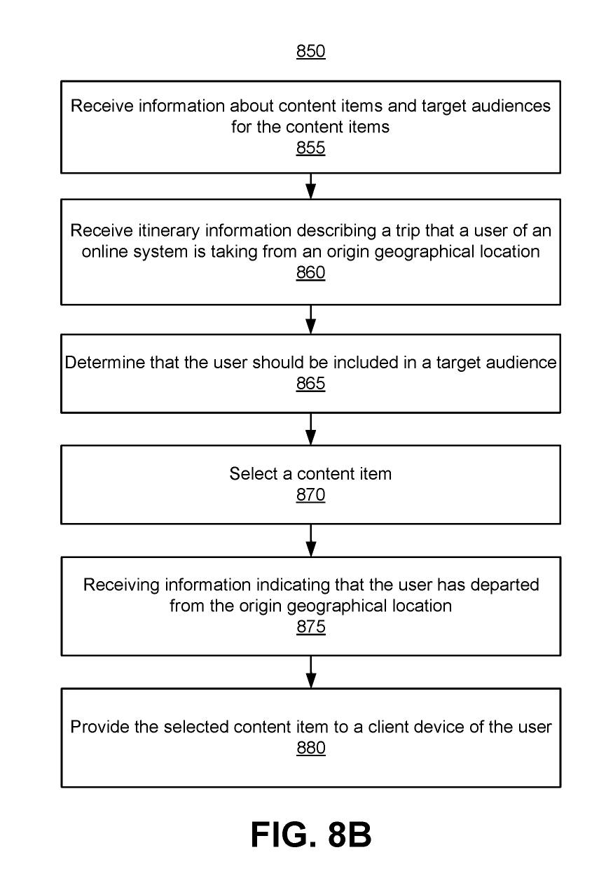

FIG. 8A is a flowchart illustrating a process 800 for providing a travel related content item during a user's trip according to one embodiment. In some embodiments, the process 800 is used by the online system 100—e.g., modules of the online system 100 described with reference to FIG. 2—within the system environment in FIG. 1. The process 800 may include different or additional steps than those described in conjunction with FIG. 8A in some embodiments or perform steps in different orders than the order described in conjunction with FIG. 8A.

In one embodiment, the online system 100 receives 805 itinerary information describing a first vehicle that a user of the online system 100 is taking for a first trip, where the first trip has an arrival time at a geographical location. For instance, for the first trip, the user is traveling on an airplane to LAX airport. The machine learning engine 265 retrieves 810 a machine learning model trained using feature vectors derived based on trips taken by a population of users of the online system 100. The machine learning engine 265 derives 815 a feature vector based on the itinerary information. The machine learning engine 265 provides 820 the feature vector as input to the machine learning model.

The machine learning model selects 825 a content item describing a second trip associated with a second vehicle having availability at the geographical region, for example, within a predetermined period of time following the arrival time. For instance, the first vehicle is an airplane and the second vehicle provides transport on land, e.g., a rental car, train, subway, taxi, etc. The online system 100 receives 830 information indicating that the user has arrived at the geographical location (e.g., based on a user's estimated flight arrival time at an airport or geographical data from the user's client device). The content engine 270 provides 835 the selected content item for display on a client device 110 of the user in response to receiving the information and prior to the user departing from the geographical location. For instance, the content item describes a rental car available at LAX airport that the user can pick up at the airport and use for the user's second trip, e.g., traveling to the user's hotel or a beach in Los Angeles.

FIG. 8B is a flowchart illustrating another process 850 for providing a travel related content item during a user's trip according to one embodiment. In some embodiments, the process 850 is used by the online system 100—e.g., modules of the online system 100 described with reference to FIG. 2—within the system environment in FIG. 1. The process 850 may include different or additional steps than those described in conjunction with FIG. 8B in some embodiments or perform steps in different orders than the order described in conjunction with FIG. 8B.

In one embodiment, the online system 100 receives 855, from third party systems 120, information about a set of content items for display to users of the online system 100 with a travel itinerary. The information may define a set of target audiences for the set of content items. The online system 100 receives 860, from the third party systems 120, itinerary information describing a trip that a user of the online system 100 is taking. The trip may be associated with a first vehicle, a departure time from an origin geographical location, and an arrival time at a destination geographical location. The rules engine 280 determines 865 that the user should be included in a target audience of the set of target audiences.

In response to determining that the user should be included in the target audience, the content engine 270 selects 870 a content item of the set of content items based on the itinerary information. The selected content item is associated with a second vehicle having an availability at the destination geographical location within a predetermined period of time following the arrival time. The online system 100 receives 875 information indicating that the user has departed from the origin geographical location. The content engine 270 provides 880, in response to receiving the information, the selected content item to a client device 110 of the user.

VI. D. Content Items with Loyalty Program Information

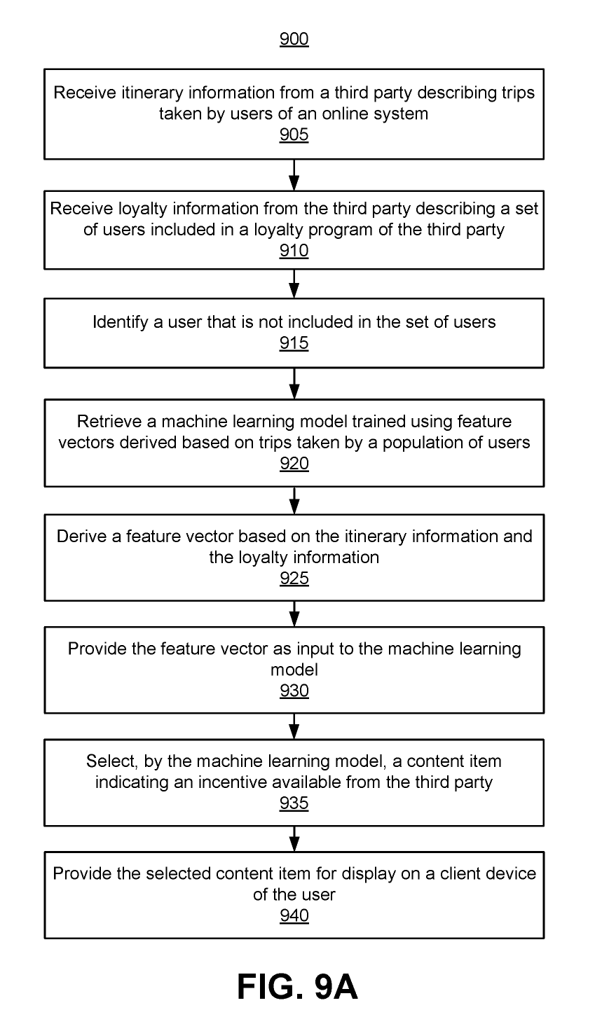

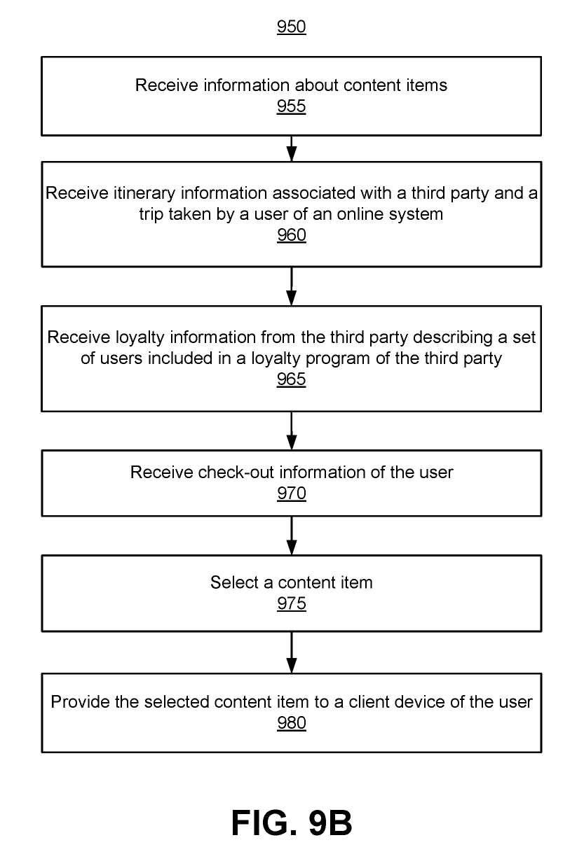

FIG. 9A is a flowchart illustrating a process 900 for providing a travel related content item associated with a loyalty program according to one embodiment. In some embodiments, the process 900 is used by the online system 100—e.g., modules of the online system 100 described with reference to FIG. 2—within the system environment in FIG. 1. The process 900 may include different or additional steps than those described in conjunction with FIG. 9A in some embodiments or perform steps in different orders than the order described in conjunction with FIG. 9A.

In one embodiment, the online system 100 receives 905 itinerary information from a third party describing trips taken by users of the online system 100. Each trip may indicate a check-out date of the corresponding user. The online system 100 receives 910 loyalty information from the third party describing a set of users included in a loyalty program of the third party. The online system 100 identifies 915 a user that is not included in the set of users. For instance, a hotel has a loyalty program to provide incentives to users who frequently stay at the hotel. Since users may voluntarily join the hotel's loyalty program, not all users are included in the program. The hotel may be interested in incentivizing more users to join its loyalty program, for example, to provide content items customized to the users that may increase the likelihood that the users will stay at the hotel during future trips. The content items may describe, for example, events occurring nearby the hotel or special amenities available at the hotel for users who are included in the loyalty program.

The machine learning engine 265 retrieves 920 a machine learning model trained using feature vectors derived based on trips taken by a population of users of the online system 100. For example, the population of users includes users who are included in the loyalty program (e.g., of the hotel) and the feature vectors indicate actions performed by the population of users during the trips (e.g., what type of hotel room the users stayed at or certain amenities that the users used such as room service). The machine learning engine 265 derives 925 a feature vector based on the itinerary information and the loyalty information. The machine learning engine 265 provides 930 the feature vector as input to the machine learning model.

The machine learning model selects 935 a content item indicating an incentive available from the third party, based on the feature vector. The incentive may include, for example, points (or any other form of credit) that the user can use for future stays at the hotel, compensation, admission to an event or activity nearby the hotel (e.g., tickets to a music concert or sports game), or lodging at the hotel for future trips. The machine learning model may determine the incentive based on a trip taken by the user such as the user's most recent stay at the hotel. In one embodiment, the incentive includes an amount of points or credit that is proportional to the number of nights that the user stayed at the hotel during the user's most recent stay. Additionally, the incentive may be determined based on whether the user stayed at the hotel for a threshold number of nights or for a threshold number of trips within a certain time period. The content engine 270 provides 940 the selected content item for display on a client device 110 of the user within a predetermined period of time following the check-out date of the user.

FIG. 9B is a flowchart illustrating another process 950 for providing a travel related content item associated with a loyalty program according to one embodiment. In some embodiments, the process 950 is used by the online system 100—e.g., modules of the online system 100 described with reference to FIG. 2—within the system environment in FIG. 1. The process 950 may include different or additional steps than those described in conjunction with FIG. 9B in some embodiments or perform steps in different orders than the order described in conjunction with FIG. 9B.

In one embodiment, the online system 100 receives 955, from third party systems 120, information about a set of content items for display to users of an online system 100 with a travel itinerary. The online system 100 receives 960, from one of the third party systems 120, itinerary information associated with a third party and with a trip that a user of the online system 100 is taking. The online system 100 receives 965 loyalty information from the third party system describing a set of users included in a loyalty program of the third party, where the user is not currently included in the set of users. The online system 100 receives 970 check-out information of the user indicating a check-out data of the user.

In response to receiving the check-out information, the rules engine 280 selects 975 a content item of the set of content items indicating an incentive available from the third party based at least in part on the itinerary information and the loyalty information. The content engine 270 provides 980 within a predetermined period of time following the check-out date, the selected content item to a client device 110 of the user.

### VII. Alternative Embodiments

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable non-transitory medium containing computer program code instructions, which can be executed by a computer processor for performing any or all of the steps, operations, or processes described.

Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer program product comprising a non-transitory computer readable storage medium having instructions encoded thereon that, when executed by a processor, cause the processor to:
receive itinerary information from a computer server of a third party describing trips each taken by one of a plurality of users of an online system, each trip indicating a check-out date;
receive loyalty information from the computer server describing a set of users included in a loyalty program of the third party;
identify a user of the plurality of the users of the online system that is not currently included in the set of users included in the loyalty program of the third party;
retrieve a machine learning model trained using feature vectors derived based on trips taken by a population of users of the online system;
derive a feature vector based on the itinerary information and the loyalty information;
provide the feature vector as input to the machine learning model;
select a content item indicating an incentive available from the third party using the machine learning model based on the feature vector; and
provide, within a predetermined period of time following the check-out date of the user, the selected content item for display on a client device of the user.

2. The non-transitory computer readable storage medium of claim 1, the instructions when executed by the processor further causing the processor to:
determine a number of users of the set of users that the user is connected to on the online system;
wherein the input provided to the machine learning model further comprises the number of users.

3. The non-transitory computer readable storage medium of claim 1, the instructions when executed by the processor further causing the processor to:
determine at least one characteristic in common between the user and each user of a subset of the set of users;
wherein the input provided to the machine learning model further comprises the at least one characteristic.

4. The non-transitory computer readable storage medium of claim 1, the instructions when executed by the processor further causing the processor to:
determine a likelihood that the user will acquire the incentive based on information describing actions performed by the user on the online system;
wherein the input provided to the machine learning model further comprises the likelihood that the user will acquire the incentive.

5. The non-transitory computer readable storage medium of claim 4, wherein determining the likelihood that the user will acquire the incentive is further based on actions performed by at least one of the users in the set of users on the online system.

6. The non-transitory computer readable storage medium of claim 1, wherein the check-out date of the user is a date on which the user checks out of a hotel associated with the third party.

7. The non-transitory computer readable storage medium of claim 6, wherein the input provided to the machine learning model further comprises a number a nights that the user stayed at the hotel.

8. The non-transitory computer readable storage medium of claim 6, wherein the loyalty information indicates a number of nights each user of the set of users has stayed at the hotel, wherein selecting the content item is further based on the number of nights.

9. The non-transitory computer readable storage medium of claim 6, the instructions when executed by the processor further causing the processor to:
determine that each user of the set of users stayed at the hotel within another predetermined period of time preceding the check-out date of the user;
wherein selecting the content item is further based on the determination.

10. A method comprising:
receiving itinerary information from a computer server of a third party describing trips each taken by one of a plurality of users of an online system, each trip indicating a check-out date;
receiving loyalty information from the computer server describing a set of users included in a loyalty program of the third party;
identifying a user of the plurality of users that is not currently included in the set of users included in the loyalty program of the third party;
retrieving a machine learning model trained using feature vectors derived based on trips taken by a population of users of the online system;
deriving a feature vector based on the itinerary information and the loyalty information;
providing the feature vector as input to the machine learning model;
selecting a content item indicating an incentive available from the third party using the machine learning model based on the feature vector; and
providing, within a predetermined period of time following the check-out date of the user, the selected content item for display on a client device of the user.

11. The method of claim 10, further comprising:
determining a number of users of the set of users that the user is connected to on the online system;
wherein the input provided to the machine learning model further comprises the number of users.

12. The method of claim 10, further comprising:
determining at least one characteristic in common between the user and each user of a subset of the set of users;
wherein the input provided to the machine learning model further comprises the at least one characteristic.

13. The method of claim 10, further comprising:
determining a likelihood that the user will acquire the incentive based on information describing actions performed by the user on the online system;
wherein the input provided to the machine learning model further comprises the likelihood that the user will acquire the incentive.

14. The method of claim 13, wherein determining the likelihood that the user will acquire the incentive is further based on actions performed by at least one of the users in the set of users on the online system.

15. The method of claim 10, wherein the check-out date of the user is a date on which the user checks out of a hotel associated with the third party.

16. The method of claim 15, wherein the input provided to the machine learning model further comprises a number a nights that the user stayed at the hotel.

17. The method of claim 15, wherein the loyalty information indicates a number of nights each user of the set of users has stayed at the hotel, wherein selecting the content item is further based on the number of nights.

18. The method of claim 15, further comprising determining that each user of the set of users stayed at the hotel within another predetermined period of time preceding the check-out date of the user, wherein selecting the content item is further based on the determination.

19. A method comprising:
receiving, by an online system from a plurality of third party computer servers, information about a plurality of content items for display to users of the online system with a travel itinerary;
receiving itinerary information from a third party computer server of the plurality of third party computer servers associated with a third party and associated with a trip of a user of the online system;
receiving loyalty information from the third party computer server describing a set of users included in a loyalty program of the third party, the user not currently included in the set of users;
receiving check-out information from the third party computer server indicating a check-out date of the user;
selecting, in response to receiving the check-out information, a content item of the plurality of content items indicating an incentive available from the third party based at least in part on the itinerary information and the loyalty information; and
providing, within a predetermined period of time following the check-out date of the user, the selected content item to a client device of the user.

20. The method of claim 19, wherein the check-out date of the user is a date on which the user checks out of a hotel associated with the third party.
